(19) United States
(12) Patent Application Publication
(10) Pub. No.: US 2021/0207707 A1
(43) Pub. Date: Jul. 8, 2021

(54) OPERATING DEVICE FOR A SHIFT BY WIRE ASSEMBLY

(71) Applicant: ZF Friedrichshafen AG

(72) Inventors: Gerhard Gumpoltsberger, Friedrichshafen (DE); Ludger Rake, Steinfeld (DE); Thomas Wenzel, Weißensberg (DE)

(73) Assignee: ZF Friedrichshafen AG, Friedrichshafen (DE)

(21) Appl. No.: 16/068,028

(22) PCT Filed: Dec. 8, 2016
(86) PCT No.: PCT/EP2016/080205

§ 371 Date: Jul. 3, 2018

(30) Foreign Application Priority Data
Jan. 5, 2016 (DE) 10 2016 200 029.2

(51) Int. Cl. F16H 59/10; B60W 50/08; F16H 59/02; F16H 59/12

(52) U.S. Cl. CPC F16H 59/10; B60W 50/082; F16H 59/0217; F16H 2059/081; B60W 2540/16; B60W 2540/215; F16H 2059/0221; F16H 59/12

(57) ABSTRACT

An operating device for a shift by wire assembly in an automobile includes a selection apparatus configured to select an operation mode (R, N, D) of the automobile, wherein the selectable operation modes comprise a reverse operation mode (R), a neutral operation mode (N) and a drive operation mode (D), wherein the selection apparatus is further configured to select an autonomous drive operation mode (AD).

### BACKGROUND

The invention relates to an operating device for a shift by wire assembly in an automobile with a selection apparatus configured to select an operation mode of the automobile, wherein the selectable operation modes comprise a reverse operation mode, a neutral operation mode and a drive operation mode. Such operating devices, for example gear shifting levers, generally comprise an selection apparatus that can be interacted with by an operator of the automobile having at least one sensor for sensing a change and/or position of the selection apparatus, as well as a communication interface, one or more processors, memory and one or more programs, wherein the one or more programs are stored in the memory and configured to be executed by the one or more processors, said programs including instructions for detecting an operator interaction with the selection apparatus, in particular by reading in an signal from the sensors, and for outputting an operation mode selection signal via the communication interface when a predefined operator interaction for selecting one of the said operation modes is detected.

With the advances in sensing and computing technologies automobiles have been increasingly designed and produced to have driver assistance functions such as, for example, a lane keeping assistance function and/or an active cruise control function, which can adjust the speed of the automobile according to the driving situation, taking into account speed limits and obstacles, such as other vehicles or traffic jams, on the road ahead. Automobiles have even been produced which drive autonomously, signaling the driver, i.e. operator, of the automobile to take control only when predetermined system limits are reached.

Traditionally, such driver assistance functions and/or autonomous drive operation modes of an automobile have been selected by the operator via an additional selection apparatus attached to the steering wheel or arranged on the center console of the automobile. It is disclosed, for example, on page 123 of the magazine “Auto Motor and Sport, Heft 26, 10 Dec. 2015”, that the operator of an automobile with an autopilot function presses a button to deactivate an autopilot function and retake control of the vehicle.

### SUMMARY

In this context, the object of the invention is to suggest an operating device for simplifying the selection of an autonomous drive operation mode in an automobile as well as an automobile featuring such an operating device.

The object of the invention is achieved with the subject matter of independent claim 1 as well as of the dependent claim 11. The dependent claims describe preferred embodiments of the invention.

The object of the invention is therefore achieved with an operating device for a shift by wire assembly in an automobile with a selection apparatus configured to select an operation mode of the automobile, wherein the selectable operation modes comprise a reverse operation mode, a neutral operation mode and a drive operation mode, and wherein the selection apparatus is further configured to select an autonomous drive operation mode. The selection of and control over an autonomous drive operation mode is therefore integrated into the operating device, which reduces the cost and complexity and installation space required by traditional systems for operating assistive functions or autonomous drive operation modes, since an additional operating device with an additional electronics unit is no longer required, and makes the selection of an autonomous drive operation mode more intuitive since operators of automobiles are generally familiar with the selection of reverse, drive and neutral operation modes via such an operating device.

An autonomous drive operation mode in the sense of the invention is an operation mode in which a processing unit of the automobile controls the guidance of the automobile in all directions, in particular in both the forwards and backwards directions as well as side to side directions, in certain driving situations and signals an operator i.e. driver of the automobile when certain predetermined parameters are exceeded, wherein the parameters are defined according to the system's capacity to control and guide the automobile safely in a current driving situation.

In an embodiment of the invention the operation device is configured to output an operation mode selection signal for selecting the autonomous drive operation mode only when the drive operation mode is engaged. Since the autonomous drive operation mode is selected when the drive operation mode is engaged, the risk of damage to the gear change mechanism due to an operator error in operating the operation device is reduced regardless of an electronic safety circuit that may be additionally present.

In an embodiment of the operating device the selectable operation modes are selectable according to a shift pattern of the selection apparatus, wherein the shift pattern is arranged such that a position in the shift pattern for selecting the autonomous drive operation mode can only be reached from a position in the shift pattern for selecting the drive operation mode.

In an embodiment of the invention the operating device comprises a first shift gate for selecting the reverse operation mode, the neutral operation mode and the drive operation mode and a second shift gate for selecting the autonomous drive operation mode.

In a further development of the embodiment the second shift gate intersects with the first shift gate at a position of the first shift gate for selecting the drive operation mode.

According to an alternative embodiment of the invention the selection apparatus is embodied as a rotary control device that is configured to select the autonomous drive operation mode by rotating to a rotary position immediately following or preceding a rotary position for selecting the drive operation mode.

According to a further alternative embodiment of the invention the selection apparatus is embodied as a rotary control device comprising a selection switch for selecting the autonomous drive operation mode, wherein the selection switch is arranged along an axis of rotation of the rotary control device.

In an embodiment of the inventive operating device the selection apparatus is embodied having a touch sensitive display, wherein the touch sensitive display is configured to detect a touch gesture of an operator corresponding to the selection of the operation mode. The touch sensitive display could, for example, be an organic light emitting diode display with an integrated touch sensor system, molded together through a process involving film-insert-molded electronics for example. Alternatively, the touch sensitive display can comprise a rear projection polycarbonate film with an integrated and/or attached touch sensor system. The touch sensitive display can also be, for example, a liquid crystal display or thin film transistor display having integrated touch sensors.

In a further development of the embodiment of the inventive operating device the touch sensitive display is configured to display an image, said image being a graphical, interactive user-interface object, which can be moved according to the touch gesture of the operator into a predetermined area of the touch sensitive display for selecting the drive operation mode, and in that the image can be moved through the predetermined area to a further distinct autonomous drive selection area for selecting the autonomous drive operation mode. The operation mode can be displayed on the touch sensitive display. Further, the touch sensitive display can be configured to display the currently selected operation mode, in particular by displaying it at the location of the area designated for selecting the currently selected operation mode, such as the predetermined area of the touch sensitive display for selecting the drive operation mode or the distinct autonomous drive selection area for selecting the autonomous drive operation mode.

In an embodiment of the inventive operating device the selection apparatus is embodied as a joystick and/or mouse control device, and in that the joystick and/or mouse control device comprises a selection switch for selecting the autonomous drive operation mode.

The object is further achieved with an automobile comprising an operating device according to one of the embodiments described above, further comprising an automatized steering wheel comprising sensors that monitor whether the operator is contacting the steering wheel, an evaluation unit and communication pathways for transferring data between the evaluation unit and the steering wheel as well as between the evaluation unit and the operating device, wherein the automobile engages the autonomous drive operation mode when a corresponding selection signal for selecting the autonomous drive operation mode is transferred via the communication pathway to the evaluation unit and when the sensors detect that the operator has released the steering wheel.

### BRIEF DESCRIPTION OF DRAWINGS

Certain embodiments of the invention will next be explained in detail with reference to the following figures. They show:

FIG. 1 a, b: a schematic representation of a conventional shift pattern and a schematic representation of a shift pattern according to an embodiment of the invention;

FIG. 2: a schematic representation of a shift pattern according to an embodiment of the invention; and

FIG. 3: a schematic representation of a shift pattern according to an embodiment of the invention;

FIG. 4a, b: a schematic representation of a conventional shift pattern for a rotary control device and a schematic representation of a conventional shift pattern for a rotary control device according to an embodiment of the invention;

FIG. 5a, b: a schematic representation of a conventional shift pattern for a monostable rotary control device and a schematic representation of a conventional shift pattern for a monostable rotary control device according to an embodiment of the invention;

FIG. 6a, b, c, d: various top views of an embodiment of the invention comprising a touch sensitive display;

FIG. 7: a perspective view of a joystick shifter with an integrated display according to an embodiment of the invention;

FIG. 8: a perspective view of a joystick shifter with an integrated rotary control device according to an embodiment of the invention;

FIG. 9: a perspective view of a mouse shifter according to an embodiment of the invention;

FIG. 10: a perspective view of a monostable joystick shifter according to an embodiment of the invention.

### DETAILED DESCRIPTION

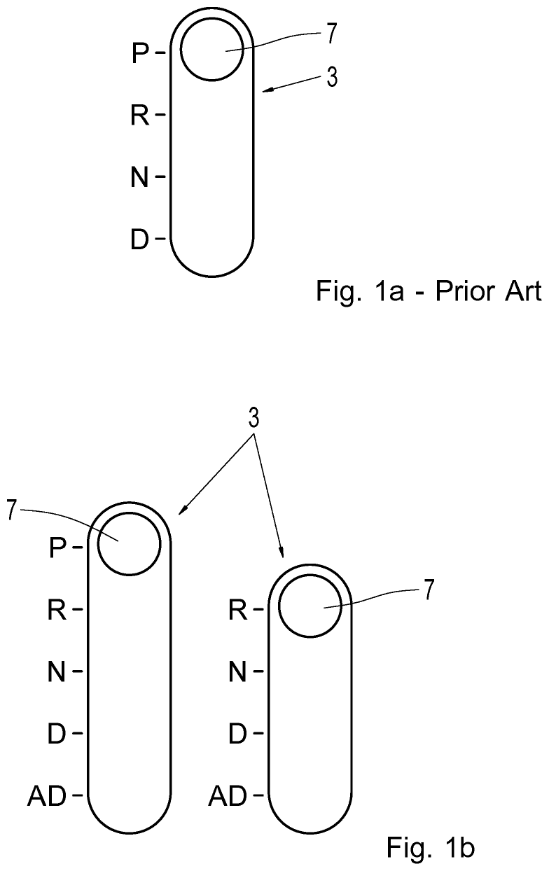

FIG. 1a shows a schematic representation of a conventional shift pattern 3 for an automatic shift by wire operation mode selection assembly. Four positions are designated for the operation modes park P, reverse R, neutral N and drive D. A selection apparatus 5 comprising such a shift pattern 3 generally comprises some sort of selection lever 7, which can be moved to the different positions. The movement and current location of the selection lever 7 is detected by sensors and an operation mode selection signal is output by a communication interface of the operating device to an evaluation unit, which serves to control a transmission of the vehicle and correspondingly controls actuators of the transmission to engage the selected operation mode P, R, N, D.

FIG. 1b shows a schematic representation of a shift pattern 3 according to an embodiment of the invention, wherein an additional position for selecting an autonomous drive operation mode AD has been added. The shift pattern 3 is shown with and without a position of selecting the park operation mode P, which can be selected automatically by the automobile when the automobile comes to a stop, or can be selected via an additional button for engaging the park lock. When the gear lever 7 is moved to the position for selecting the autonomous drive operation mode AD, a signal is output via a communication interface of the operating device and sent to an evaluation unit, that is a central processing unit of the automobile. Generally speaking, the evaluation unit can be electrically and/or electronically connected to various component groups of the automobile such as a component group for automating the steering wheel as well as various other chassis and powertrain component groups. When a selection signal for selecting the autonomous drive operation mode AD reaches the evaluation unit, i.e. the central processor of the automobile, the processor can assess the information it is continually receiving from the component groups as well as from sensor groups such as radar based sensor devices or cameras mounted on the vehicle to assess whether certain requirements for engaging and autonomous drive operation mode AD are met. If the necessary criteria are fulfilled then the central processor unit will begin to issue commands to control the component groups responsible, for example, for steering, acceleration, torque conversion, damping, etc. of the vehicle, essentially taking control of the vehicle from the operator V.

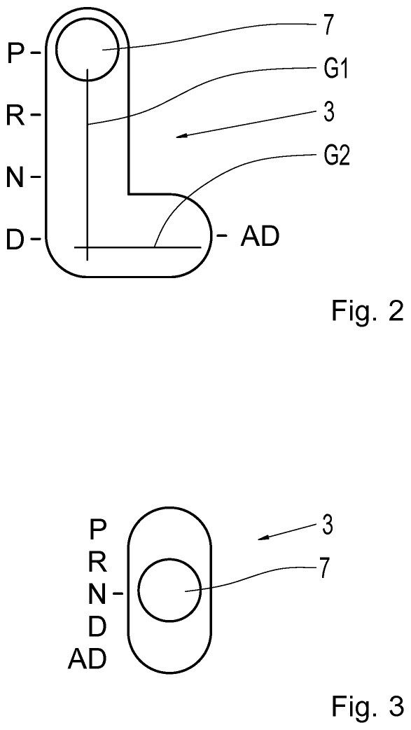

FIG. 2 shows a schematic representation of a shift pattern 3 according to an embodiment of the invention, wherein two shift gates G1, G2 are shown. A first shift gate G1 corresponds essentially to a conventional shift gate as shown in FIG. 1a. A second shift gate G2 comprises a position for selecting the autonomous drive operation mode AD, wherein the second gate G2 intercepts the first gate G1 at the position for selecting the drive operation mode D, so that the autonomous drive operation mode AD can only be selected starting from the drive operation mode D.

FIG. 3 shows a schematic representation of a shift pattern 3 according to an embodiment of the invention, wherein the selection apparatus 5 comprises a monostable selection mechanism. As is shown, the position for selecting the autonomous drive operation mode AD can only be reached by shifting through the position for selecting the drive operation mode D.

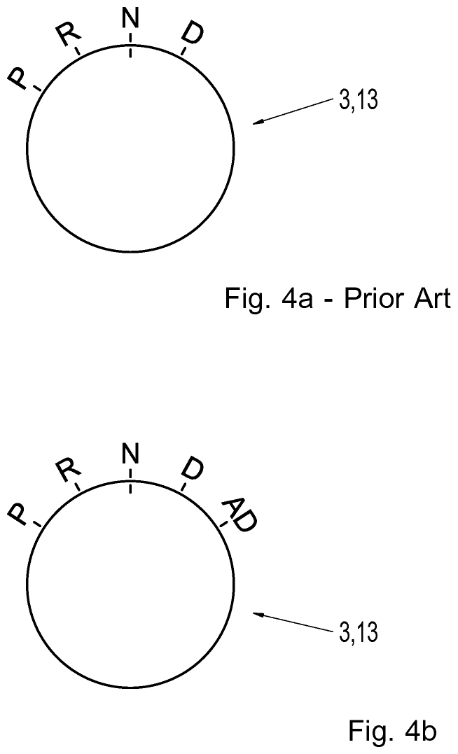

FIG. 4a shows a schematic representation of a conventional shift pattern 3 for a multistable rotary control device 13. As is conventionally expected, there are positions for selecting the park, reverse, neutral and drive operation modes P, R, N, D. FIG. 4b shows a schematic representation of a shift pattern 3 for a rotary control device 13 according to an embodiment of the invention wherein a position for selecting the autonomous drive operation mode has been added at the rotational limit of the rotary device 13.

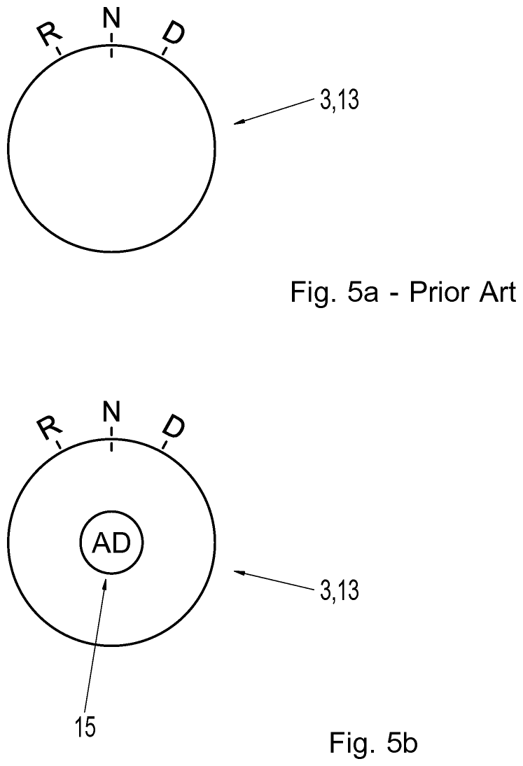

FIG. 5a shows a schematic representation of a conventional shift pattern 3 for a monostable rotary control device 13 and FIG. 5b shows a schematic representation of a conventional shift pattern 3 for a monostable rotary control device 13 according to an embodiment of the invention, wherein a button 15 for selecting the autonomous drive operation mode AD is comprised by the rotary control device 13. The button 15 is situated in the center of the rotary device 13, arranged on the axis of rotation.

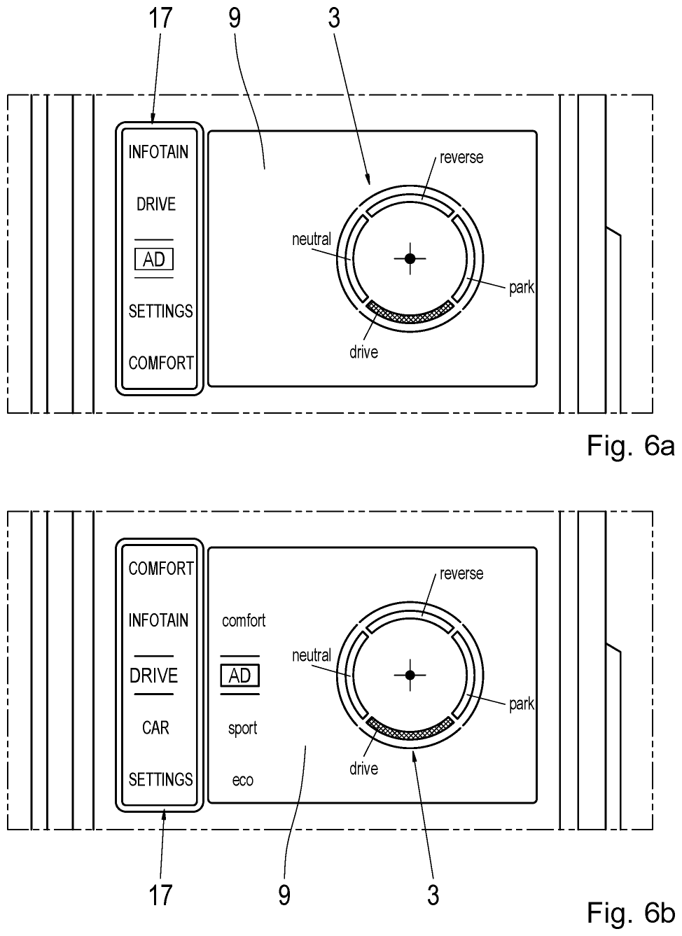

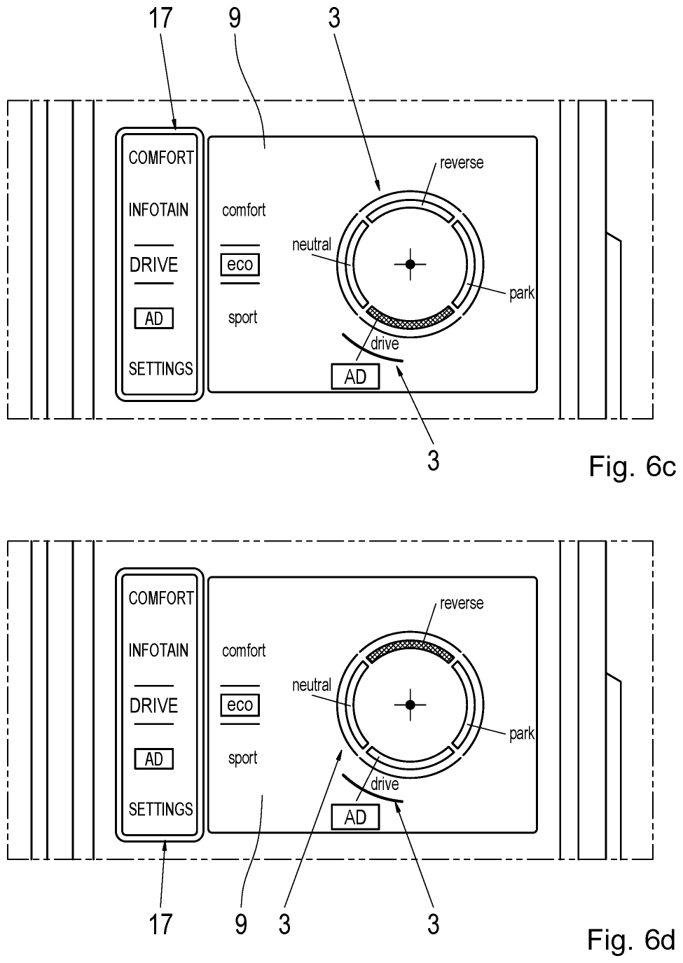

FIGS. 6a-d show various top views of an embodiment of the invention comprising a touch sensitive display 9. A shift pattern 3 is displayed on the touch sensitive display 9, wherein the shift pattern 3 is divided into quadrants for selecting the various operation modes park P, reverse R, neutral N, and drive D. An information display area 17 can display a currently selected operation mode P, R, N, D, AD for example, or it can display a recommended operation mode according to an assessment carried out by the central processing unit. In FIG. 6c the selection of the autonomous operation mode AD is shown, wherein an operator V has applied pressure to the touch sensitive display 9 in a sliding touch gesture through and beyond a predetermined an area 19 displayed in a quadrant for selecting drive D into an area designated for selecting the autonomous drive operation mode AD.

FIG. 7 shows a perspective view of a joystick shifter with an integrated display 21 according to an embodiment of the invention. The joystick has a button 15 integrated into the grip for selecting the autonomous drive operation mode AD.

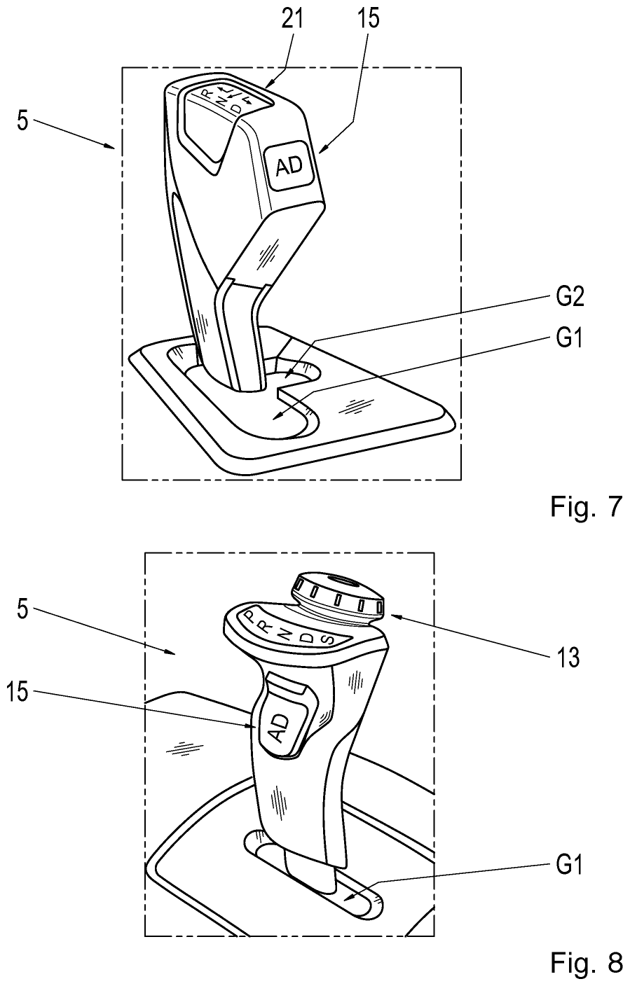

FIG. 8 shows a perspective view of a joystick shifter with an integrated rotary control device 13 according to an embodiment of the invention, wherein a button 15 is integrated into the handle of the joystick for selecting the autonomous drive operation mode AD.

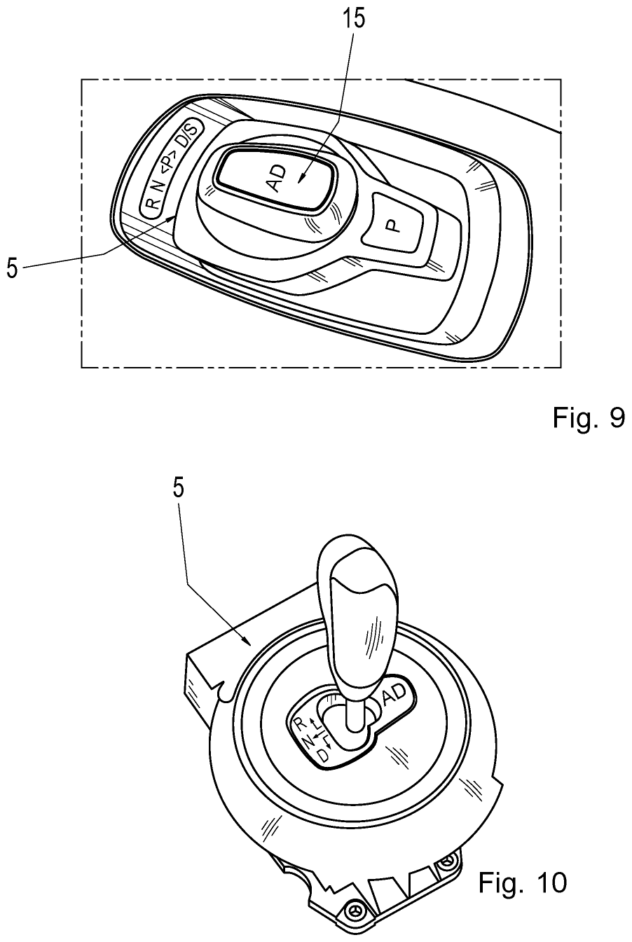

FIG. 9 shows a perspective view of a mouse shifter according to an embodiment of the invention, wherein a button 15 for selecting the autonomous drive operation mode AD is integrated into the upper surface of the mouse.

FIG. 10 shows a perspective view of a monostable joystick shifter according to an embodiment of the invention. Here the autonomous drive operation mode AD can be selected by moving the joystick in a direction opposite a direction for selection the neural operation mode N. In conventional monostable joysticks of this sort, the position for selecting the autonomous drive operation mode AD is traditionally occupied by a position for engaging the parking lock P.

### REFERENCE CHARACTERS

1 operating device
3 shift pattern
5 selection apparatus
7 selector lever
9 touch sensitive display
13 rotary control device
15 button
17 information display area
19 predetermined area for selecting drive
21 integrated display
G1 first shift gate
G2 second shift gate
P park operation mode
R reverse operation mode
N neutral operation mode
D drive operation mode
AD autonomous drive operation mode

1. An operating device for a shift by wire assembly in an automobile, the operating device comprising a selection apparatus configured to select an operation mode of a plurality of operation modes (R, N, D) of the automobile, wherein the plurality of operation modes comprises a reverse operation mode (R), a neutral operation mode (N) and a drive operation mode (D), the selection apparatus further configured to select an autonomous drive operation mode (AD).

2. The operating device according to claim 1, wherein the operation device is configured to output an operation mode selection signal for selecting the autonomous drive operation mode (AD) only when the drive operation mode (D) is engaged.

3. The operating device according to claim 1, wherein the operation mode is selectable according to a shift pattern of the selection apparatus, wherein the shift pattern is arranged such that a position in the shift pattern for selecting the autonomous drive operation mode (AD) can only be reached from a position in the shift pattern for selecting the drive operation mode (D).

4. The operating device according to claim 1, wherein the operating device comprises a first shift gate (G1) for selecting the reverse operation mode (R), the neutral operation mode (N) and the drive operation mode (D) and a second shift gate for selecting the autonomous drive operation mode (AD).

5. The operating device according to claim 4, wherein the second shift gate (G2) intersects with the first shift gate (G1) at a position of the first shift gate (G1) for selecting the drive operation mode (D).

6. The operating device according to claim 1, wherein the selection apparatus is embodied as a rotary control device that is configured to select the autonomous drive operation mode (AD) by rotating to an additional rotary position immediately following or preceding a rotary position for selecting the drive operation mode (D).

7. The operating device according to claim 1, wherein the selection apparatus is embodied as a rotary control device comprising a selection switch for selecting the autonomous drive operation mode (AD), wherein the selection switch is arranged along an axis of rotation of the rotary control device.

8. The operating device according to claim 1, wherein the selection apparatus comprises a touch sensitive display, wherein the touch sensitive display is configured to detect a touch gesture of an operator (V) corresponding to the selection of the operation mode (P, R, N, D, AD).

9. The operating device according to claim 8, wherein the touch sensitive display is configured to display an image, said image being a graphical, interactive user-interface object movable according to the touch gesture of the operator (V) into a predetermined area of the touch sensitive display for selecting the drive operation mode (D), and movable through the predetermined area to an autonomous drive selection area for selecting the autonomous drive operation mode (AD).

10. The operating device according to claim 1, wherein the selection apparatus comprises one or more of the following: a joystick and a mouse control device, and wherein the one or more of the joystick and the mouse control device comprises a selection switch for selecting the autonomous drive operation mode (AD).

11. An automobile comprising an operating device according to claim 1, the automobile further comprising:
an automatized steering wheel comprising a sensor that monitor whether the operator (V) is contacting the automatized steering wheel; and
an evaluation unit and a communication pathway for transferring data between the evaluation unit and the automatized steering wheel and between the evaluation unit and the operating device, wherein the automobile engages the autonomous drive operation mode (AD) when a corresponding selection signal for selecting the autonomous drive operation mode (AD) is transferred via the communication pathway to the evaluation unit and when the sensor detect that the operator has released the automatized steering wheel.

12. An operating device for a shift by wire assembly in an automobile, the operating device comprising a selection apparatus configured to select an operation mode of a plurality of operation modes of the automobile, wherein the plurality of operation modes comprises a reverse operation mode (R), a neutral operation mode (N), a drive operation mode (D), and an autonomous drive operation mode (AD).

13. The operating device according to claim 12, wherein the operation device is configured to output a signal for selecting the autonomous drive operation mode (AD) only when the drive operation mode (D) is engaged.

14. The operating device according to claim 12, wherein the plurality of operation modes (P, R, N, D, AD) are selectable according to a shift pattern of the selection apparatus, wherein the shift pattern is arranged such that a position in the shift pattern for selecting the autonomous drive operation mode (AD) can only be reached from a position in the shift pattern for selecting the drive operation mode (D).

15. The operating device according to claim 12, wherein the operating device comprises a first shift gate (G1) for selecting the reverse operation mode (R), the neutral operation mode (N), and the drive operation mode (D), and a second shift gate for selecting the autonomous drive operation mode (AD).

16. The operating device according to claim 15, wherein the second shift gate (G2) intersects with the first shift gate (G1) at a position of the first shift gate (G1) for selecting the drive operation mode (D).

17. The operating device according to claim 12, wherein the selection apparatus comprises a rotary control device configured to select the autonomous drive operation mode (AD) by rotating the rotary control device to an additional rotary position adjacent a rotary position for selecting the drive operation mode D.

18. The operating device according to claim 12, wherein the selection apparatus comprises a rotary control device including a selection switch configured to select the autonomous drive operation mode (AD), wherein the selection switch is arranged along an axis of rotation of the rotary control device.

19. The operating device according to claim 12, wherein the selection apparatus comprises a touch sensitive display configured to detect a touch gesture of an operator (V) corresponding to the selection of the operation mode (P, R, N, D, AD).

20. The operating device according to claim 1, wherein the selection apparatus is comprises one of a joystick or a mouse control device, and the one of the joystick or the mouse control device comprises a selection switch configured to select the autonomous drive operation mode (AD).
